(19) United States
(12) Patent Application Publication
(10) Pub. No.: US 2025/0197602 A1
(43) Pub. Date: Jun. 19, 2025

(54) RESIN COMPOSITION FOR VEHICLE COOLANT TRANSPORT TUBE AND VEHICLE COOLANT TRANSPORT TUBE

(71) Applicant: Sumitomo Riko Company Limited, Aichi (JP)

(72) Inventors: Masashi OKAHISA, Aichi (JP); Koji MIZUTANI, Aichi (JP)

(73) Assignee: Sumitomo Riko Company Limited, Aichi (JP)

(21) Appl. No.: 19/065,607

(22) Filed: Feb. 27, 2025

Related U.S. Application Data
(63) Continuation of application No. PCT/JP2023/045328, filed on Dec. 18, 2023.

(30) Foreign Application Priority Data
Dec. 23, 2022 (JP) 2022-206678

(51) Int. Cl. C08K 5/375; C08K 5/134; F16L 9/12

(52) U.S. Cl. CPC C08K 5/375; C08K 5/1345; F16L 9/12

(57) ABSTRACT

Provided are a resin composition for a vehicle coolant transport tube having excellent heat resistance and extraction resistance; and a vehicle coolant transport tube obtained by using this resin composition. The resin composition for the vehicle coolant transport tube includes a component (A): a polypropylene resin having a melt-flow rate of not less than 0.2 g/10-min and less than 2.0 g/10-min and having a melting point of not lower than 145° C., wherein the melt-flow rate is measured at 230° C. with a load of 2.16 kg; and a component (B): an antioxidant having a melting point of not lower than 60° C., wherein a content of the component (B) relative to 100 parts by mass of the component (A) is 0.1 to 1 part by mass.

### RELATED APPLICATIONS

This application is a continuation of International Application No. PCT/JP2023/045328, filed on Dec. 18, 2023, which claims priority to Japanese Patent Application No. 2022-206678, filed on Dec. 23, 2022, the entire contents of each of which are herein incorporated by reference.

### TECHNICAL FIELD

The present disclosure relates to a resin composition for a vehicle coolant transport tube and a vehicle coolant transport tube obtained by using this resin composition. The present disclosure specifically relates to a tube that has excellent heat resistance and extraction resistance and that is for transporting a coolant in a cooling system of automobiles, etc.

### BACKGROUND ART

For a material of a coolant transport tube in gasoline automobiles and electric automobiles, a polyamide resin has been conventionally adopted from the viewpoint of excellent heat resistance, etc. (for example, see JP-A-2012-091730). The polyamide resin, however, has a problem in terms of the price, and thus a polypropylene resin, which is a material advantageous in cost, has been investigated (for example, see JP-A-2006-194318).

### RELATED ART DOCUMENT

### Patent Document

JP-A-2012-091730
JP-A-2006-194318

### SUMMARY

### Problem to be Solved by the Disclosure

The case of using the polypropylene resin as the material for the vehicle coolant transport tube is excellent in terms of cost but leaves the problem of heat resistance. Thus, it is considered to blend an antioxidant from the viewpoint of improving the heat resistance.

However, blending the antioxidant as the material for the vehicle coolant transport tube tends to extract (elute) a component derived from the antioxidant into the coolant, which may lead to a risk of clogging of a filter in the vehicle cooling system or a risk of increase in conductivity of the coolant due to the extracted component to cause short circuit, electric leakage, etc.

The present disclosure has been made in view of the foregoing, and provides: a resin composition for the vehicle coolant transport tube that has excellent heat resistance and extraction resistance; and a vehicle coolant transport tube obtained by using this resin composition.

### Means for Solving the Problems

The present inventors have focused on the contradictory problem between the heat resistance and the extraction resistance when using the antioxidant in earnest study to solve the above problem. That is, it is required to increase the blending amount of the antioxidant from the viewpoint of improving the heat resistance, but the increase in the blending amount of the antioxidant causes difficulty in inhibition of the extraction amount of the component derived from the antioxidant into the coolant, which fails to achieve the extraction resistance. The present inventors have further made study from the viewpoint of achieving both the heat resistance and the extraction resistance, and consequently found that a vehicle coolant transport tube having excellent heat resistance and extraction resistance can be obtained by using a specific polypropylene resin and a specific antioxidant in combination and by setting content proportions thereof to be within a specific range. Thereby, the present disclosure has been accomplished.

Specifically, the present disclosure includes the following aspects [1] to [7].
[1] A resin composition for a vehicle coolant transport tube, the resin composition including:
   a component (A): a polypropylene resin having a melt-flow rate of not less than 0.2 g/10-min and less than 2.0 g/10-min and having a melting point of not lower than 145° C., wherein the melt-flow rate is measured at 230° C. with a load of 2.16 kg; and
   a component (B): an antioxidant having a melting point of not lower than 60° C.,
   wherein a content of the component (B) relative to 100 parts by mass of the component (A) is 0.1 to 1 part by mass.
[2] The resin composition for a vehicle coolant transport tube according to [1], wherein the component (A) is a propylene-α-olefin block copolymer.
[3] The resin composition for a vehicle coolant transport tube according to [1] or [2], wherein the melt-flow rate of the component (A) is not less than 0.2 g/10-min and not more than 1.5 g/10-min.
[4] The resin composition for a vehicle coolant transport tube according to any one of [1] to [3], wherein the melting point of the component (B) is not lower than 90° C.
[5] The resin composition for a vehicle coolant transport tube according to any one of [1] to [4], wherein the component (B) is a phenol-type antioxidant.
[6] The resin composition for a vehicle coolant transport tube according to any one of [1] to [5], wherein the component (B) is a hindered-phenol-type antioxidant.
[7] A vehicle coolant transport tube, including the resin composition for a vehicle coolant transport tube according to any one of [1] to [6].

### Effects of the Disclosure

The present disclosure can provide the vehicle coolant transport tube having excellent heat resistance and extraction resistance.

### BRIEF DESCRIPTION OF DRAWING

FIG. 1 is a view illustrating an example of a vehicle coolant transport tube according to the present disclosure.

### EMBODIMENTS OF THE DISCLOSURE

Next, embodiments of the present disclosure will be described in detail. The present disclosure is not limited to these embodiments.

The resin composition for a vehicle coolant transport tube according to one embodiment of the present disclosure (hereinafter, which may be referred to as “the present resin composition”) has features of including the following component (A) and component (B), and specifying a content of the component (B) relative to 100 parts by mass of the component (A) to be 0.1 to 1 part by mass.

The component (A) is a polypropylene resin having a melt-flow rate of not less than 0.2 g/10-min and less than 2.0 g/10-min and having a melting point of not lower than 145° C. The melt-flow rate is measured at 230° C. with a load of 2.16 kg.

The component (B) is an antioxidant having a melting point of not lower than 60° C.

The vehicle coolant transport tube is required to have excellent heat resistance because the vehicle coolant transport tube is placed close to heat sources such as an engine and a battery to be exposed to a high-temperature environment and because a coolant at high temperature is passed through thereinside.

On the other hand, when the coolant in the vehicle coolant transport tube has conductivity, an electric short circuit can occur, causing concern about risks of electric shock, decrease in efficiency of powder generation due to electric leakage, etc. Therefore, reducing conductivity of the coolant has become important. In view of such circumstances, a technical development that can contribute to reduction in conductivity of the coolant has been strongly demanded also in the vehicle coolant transport tube. Specifically, with popularization of electric automobiles and increase in voltage of a battery in recent years, an insulation requirement of the coolant is becoming more strict in view of problems caused if the coolant is leaked. Countermeasures therefor have become urgent also in the vehicle coolant transport tube.

The present resin composition is based on the background as above.

The vehicle coolant transport tube obtained by using the present resin composition has excellent heat resistance, and also excellent extraction resistance of a component (an ionic component) that can adversely affects conductivity of the coolant. Therefore, the vehicle coolant transport tube is useful in terms of reducing conductivity of the coolant.

The vehicle coolant transport tube obtained by using the present resin composition has excellent extraction resistance, and thus is useful also in terms of inhibition of clogging of the filter in the cooling system to not inhibit operation of the cooling system.

In addition, the vehicle coolant transport tube obtained by using the present resin composition uses the propylene resin, which has cost competitiveness, and thus is further useful in terms of excellent economic efficiency.

From the viewpoints of the heat resistance and the economic efficiency, a multilayer-structured tube having a polyamide resin layer and a polypropylene resin layer has been conventionally proposed, but such a tube is poor at recycling properties because it is difficult to peel the layers in recycling. The vehicle coolant transport tube obtained by using the present resin composition can exhibit excellent properties such as heat resistance and economic efficiency even with a single-layered structure, and, therefore, the vehicle coolant transport tube obtained by using the present resin composition is useful in terms of not only excellent heat resistance and economic efficiency but also excellent recycling properties.

Hereinafter, materials to constitute the present resin composition, etc. will be described.

In the present disclosure, the expression “x and/or y,” wherein x and y are given constitutions, means at least one of x and y, and means three of: only x; only y; and x and y.

### <<(A) Polypropylene Resin>>

It is important for the polypropylene resin used in the present resin composition that a melt-flow rate measured under a condition at 230° C. with a load of 2.16 kg (hereinafter, which may be referred to as an abbreviation “MFR”) is not less than 0.2 g/10-min and less than 2.0 g/10-min and a melting point is not lower than 145° C.

The present resin composition can yield the expected extraction resistance and heat resistance by using the polypropylene resin having the MFR within the above range and the melting point within the above range. If the MFR of the component (A) is not less than 2.0 g/10-min or if the melting point of the component (A) is lower than 145° C., the extraction amount into the coolant tends to increase due to deteriorated compatibility between the component (A) and the component (B), and thus it is difficult to highly achieve both the heat resistance and the extraction resistance.

Note that the MFR is measured in accordance with JIS K7210:1999 under a condition at 230° C. with a load of 2.16 kg.

From the viewpoint of remarkably exhibiting the effect of the present disclosure, the MFR of the component (A) is preferably not less than 0.3 g/10-min, more preferably not less than 0.4 g/10-min, and furthermore preferably not less than 0.5 g/10-min. The MFR is preferably not greater than 1.8 g/10-min, more preferably not greater than 1.6 g/10-min, and furthermore preferably not greater than 1.5 g/10-min.

From the viewpoint of remarkably exhibiting the effect of the present disclosure, the melting point of the component (A) is preferably not lower than 148° C., more preferably not lower than 150° C., and furthermore preferably not lower than 155° C. An upper limit of the melting point of the component (A) is not particularly limited, and about 175° C., for example.

Note that the melting point herein may be measured by using a method in accordance with JIS K7121:2012, for example.

Specific examples of the component (A) include one or more propylene polymers selected from the group consisting of propylene homopolymer, a propylene-α-olefin random copolymer, and a propylene-α-olefin block copolymer.

Examples of the α-olefin used for these copolymers include ethylene, 1-butene, 1-hexene, 4-methyl-1-pentene, and 1-octene. Among these, ethylene, 1-butene, and 1-hexene are preferable, and ethylene is particularly preferable.

Examples of the component (A) include a modified polypropylene resin in which the above polypropylene resin is modified with at least one modifying compound selected from the group consisting of an acid and an acid derivative.

Examples of the acid or the derivative thereof for the acid-modified product include an unsaturated carboxylic acid and a derivative thereof. Examples of the unsaturated carboxylic acid include maleic acid, fumaric acid, acrylic acid, and methacrylic acid. Examples of the derivative of the unsaturated carboxylic acid include an acid anhydride, an ester compound, an amide compound, an imide compound, and a metal salt of the above unsaturated carboxylic acid.

Examples of the component (A) also include an alloy (a mixture) having a sea-island structure of: a polypropylene component such as the homopolymer of propylene (homo-polypropylene) as above as a sea phase; and for example, a polyethylene component or an ethylenic rubber component as an island phase.

Examples of the polyethylene component include ethylenic copolymers such as ethylene homopolymer, ethylene-vinyl acetate copolymer, ethylene-acrylic acid copolymer, ethylene-methacrylic acid copolymer, and a copolymer of ethylene and an α-olefin (ethylene-propylene copolymer, ethylene-butene copolymer, or ethylene-octene copolymer). Examples of the ethylenic rubber component include ethylene-propylene-diene ternary copolymer (EPDM), ethylene-propylene copolymer (EPR), ethylene-butene copolymer (EBR), and ethylene-octene copolymer (EOR). Among the above ethylenic rubber components, ethylene-propylene copolymer (EPR) and ethylene-propylene-diene ternary copolymer (EPDM) are preferable. A content rate of the polyethylene component and/or the ethylenic rubber component in the entirety of the alloy (100 mass %) is not particularly limited, and, for example, 1 to 80 mass %, 1 to 70 mass %, 1 to 60 mass %, 1 to 55 mass %, etc., and preferably 1 to 49 mass %, 2 to 30 mass %, 2.5 to 20 mass %, etc.

Among the component (A), the propylene-α-olefin block copolymer is preferable from the viewpoint of remarkably exhibiting the effect of the present disclosure. Examples of the propylene-α-olefin block copolymer include an alloy (a mixture) having a sea-island structure of: a polypropylene component such as a homopolymer of propylene as a sea phase; and a polyethylene component and/or an ethylenic rubber component as an island phase.

Examples of the polyethylene component in the alloy include ethylene homopolymer, ethylene-propylene copolymer, ethylene-butene copolymer, and ethylene-octene copolymer. Examples of the ethylenic rubber component include ethylene-propylene-diene ternary copolymer (EPDM), ethylene-propylene copolymer (EPR), ethylene-butene copolymer (EBR), and ethylene-octene copolymer (EOR). Among the above ethylenic rubber components, ethylene-propylene copolymer (EPR) and ethylene-propylene-diene ternary copolymer (EPDM) are preferable, and ethylene-propylene copolymer (EPR) is more preferable.

A content rate of the polyethylene component and/or the ethylenic rubber component in the entirety of the alloy (100 mass %) is not particularly limited to, and, for example, 1 to 80 mass %, 1 to 70 mass %, 1 to 60 mass %, 1 to 55 mass %, etc., and preferably 1 to 49 mass %, 2 to 30 mass %, 2.5 to 20 mass %, etc.

Among the above propylene-α-olefin block copolymers, the propylene-ethylene block copolymer is preferable. The propylene-ethylene block copolymer is produced by, for example, singly polymerizing propylene (former polymerization), and then copolymerizing ethylene (latter polymerization). In the above latter polymerization, a component other than ethylene may be copolymerized. The propylene-ethylene block copolymer has a sea-island structure in which an island phase of the ethylene block or the ethylene-propylene copolymer block is dispersed in a sea phase of the polymerized propylene, and also generally called “propylene block polymer” or “block polypropylene.”

In the present resin composition, these components (A) are used singly or in combination of two or more thereof. When the component (A) is used in combination of two or more thereof, an MFR and a melting point of the polyethylene resin mixture composed of the two types are preferably within the above ranges. When the above alloy (the mixture) is used as the component (A), for example, the MFR and the melting point of the alloy are preferably within the above ranges.

The present resin composition contains the component (A) as a main component. A content of the component (A) in the entirety of the present resin composition (100 mass %) is, for example, typically not less than 50 mass %, preferably 55 to 99.9 mass %, more preferably 60 to 90 mass %, and furthermore preferably 65 to 80 mass %.

### <<(B) Antioxidant>>

It is important that the antioxidant (B) used in the present resin composition has a melting point of not lower than 60° C. If the melting point of the antioxidant (B) is lower than 60° C., the component derived from the antioxidant tends to be extracted into the coolant, and it is difficult to achieve both the extraction resistance and the heat resistance.

The melting point of the component (B) is preferably not lower than 70° C., more preferably not lower than 75° C., furthermore preferably not lower than 80° C., and particularly preferably not lower than 90° C. from the viewpoint of remarkably exhibiting the effect of the present disclosure. The melting point is preferably not higher than 300° C., and more preferably not higher than 250° C.

A molecular weight of the component (B) is not particularly limited, and, for example, preferably 550 to 1300, more preferably 580 to 1280, furthermore preferably 600 to 1250, and particularly preferably 700 to 1200.

Specific examples of the component (B) include, but not limited to, phenol-type antioxidants, amine-type antioxidants, imidazole-type antioxidants, and phosphate-type antioxidants. These may be used singly or in combination of two or more thereof. Among these, the phenol-type antioxidants are preferable from the viewpoint of remarkably exhibiting the effect of the present disclosure. Among the phenol-type antioxidants, hindered-phenol-type antioxidants are particularly preferable from the viewpoint of the heat resistance.

Examples of the hindered-phenol-type antioxidant include pentaerythritol tetrakis[3-(3,5-di-tert-butyl-4-hydroxyphenyl) propionate] (for example, “Irganox 1010,” available from BASF SE, melting point: 110 to 125° C.), 1,3,5-tris(3,5-di-tert-butyl-4-hydroxybenzyl) isocyanurate (for example, “Irganox 3114,” available from BASF SE, melting point: 218 to 223° C.), 2,4,6-tris(4-hydroxy-3,5-di-tert-butylbenzyl) mesitylene (for example, “Irganox 1330,” available from BASF SE, melting point: 240 to 245° C.), 6-(4-hydroxy-3,5-di-tert-butylanilino)-2,4-bis(octylthio)-1,3,5-triazine (for example, “Irganox 565,” available from BASF SE, melting point: 91 to 96° C.), 2,2′-thiodiethyl bis[3-(3,5-di-tert-butyl-4-hydroxyphenyl) propionate] (for example, “Irganox 1035,” available from BASF SE, melting point: 63 to 78° C.), N,N′-hexamethylene bis[3-(3,5-di-tert-butyl-4-hydroxyphenyl) propanamide] (“Irganox 1098,” available from BASF SE, melting point: 156 to 161° C.), and 1,6-hexanediol bis[3-(3,5-di-tert-butyl-4-hydroxyphenyl) propionate] (“Irganox 259,” available from BASF SE, melting point: 104 to 108° C.).

It is important that a content of the component (B) is relatively low such as 0.1 to 1 part by mass relative to 100 parts by mass of the polypropylene resin (A) from the viewpoint of exhibiting the effect of the present disclosure. If the content of the antioxidant (B) relative to the component (A) is out of the above range, it is difficult to highly achieve both the heat resistance and the extraction resistance.

### (Other Component)

In addition to the component (A) and the component (B), additives such as a filler, a weather stabilizer, a lubricant, a pigment, a dye, an antistat, a plasticizer, a crosslinker, and a crosslinking auxiliary may be appropriately blended as necessary with the material for forming the present resin composition within a range not inhibiting the effect of the present disclosure.

Examples of the filler include inorganic fillers such as talc, silica, mica, kaolin, calcium carbonate, potassium titanate, and apatite. These are used singly or in combination of two or more thereof. Among these, talc is preferable from the viewpoints of extrusion processability, reinforcing properties, etc.

A content of the filler is not particularly limited, and, for example, 1 to 100 parts by mass, and preferably 10 to 70 parts by mass relative to 100 parts by mass of the polypropylene resin (A) from the viewpoint of strength. The content of the filler may be 10 to 50 parts by mass, etc.

Examples of the crosslinker include peroxide crosslinkers such as peroxy ketal, peroxy ester, dialkyl peroxide, ketone peroxide, diacyl peroxide, and peroxy dicarbonate. These are used singly or in combination of two or more thereof. A content of the crosslinker is not particularly limited, and, for example, 0.1 to 4 parts by mass, and preferably 0.2 to 2 parts by mass relative to 100 parts by mass of the polypropylene resin (A).

### (Producing Method)

The present resin composition and the vehicle coolant transport tube formed with the present resin composition are produced by, for example, kneading the component (A), the component (B), and as necessary the above other components, and melt-extruding and forming the obtained kneaded product into a tube shape. For example, the present resin composition and the vehicle coolant transport tube can be favorably produced by performing steps described below as [I] to [III] in this order:
[I] a step of kneading the component (A) and the component (B);
[II] a step of adding the inorganic filler into the kneaded product obtained in the step [I], and kneading the mixture; and
[III] a step of melt-extruding and forming the kneaded product obtained in the step [II] into a tube shape.

The step [I] is a step of kneading, for example, the component (A), the component (B), etc. with a biaxial kneading extruder, etc. at, for example, 190 to 230° C. for 0.01 to 10 minutes.

The step [II] is a step of adding the inorganic filler into the kneaded product obtained in the step [I] and kneading the mixture. The kneading condition is, for example, with a biaxial kneading extruder, etc. at 190 to 270° C. for 0.01 to 10 minutes.

The optional components other than the component (A) and the component (B) are added in any step of the steps [I] to [III], and preferably added and mixed after the step [II]. Note that a compound having a guanamine skeleton may be optionally added into the present resin composition, but the compound having a guanamine skeleton is preferably not added from the viewpoint of extruding processability.

The step [III] is a step of melt-extruding and forming the kneaded product obtained in the step [II] with a melt-extruding forming machine equipped with a cylindrical die, etc. into a tube shape at, for example, 190 to 270° C. As the kneaded product, pellets are preferably used from the viewpoint of productivity.

The vehicle coolant transport tube of the present disclosure obtained as above has an inner diameter within a range of preferably 2.5 to 30 mm, particularly preferably 4 to 25 mm, and a thickness within a range of preferably 0.5 to 5.0 mm, particularly preferably 0.75 to 4.0 mm, from the viewpoint of the usage.

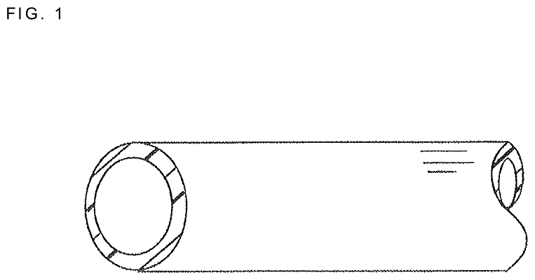

The vehicle coolant transport tube obtained from the present resin composition is suitably performed as, for example, a vehicle coolant transport tube having a single-layered structure as illustrated in FIG. 1. The vehicle coolant transport tube may also be a vehicle coolant transport tube having a multi-layered structure as necessary by further laminating another resin layer and a reinforcing fiber layer.

The vehicle coolant transport tube obtained from the present resin composition is used for, for example, a pipe for a coolant in automobiles, and specifically used for a radiator hose, a heater hose, an air conditioner hose, etc., and a cooling tube of a battery pack for electric automobiles and fuel-cell automobiles.

### EXAMPLES

Next, Examples of the present disclosure will be described together with Comparative Examples. However, the present disclosure is not limited to these Examples.

First, materials described below were prepared prior to Examples and Comparative Examples.

### <(A) Polypropylene Resin>

### Polypropylene Resin (a)

Propylene-α-olefin block copolymer (E-702 MG, available from Prime Polymer Co., Ltd., MFR: 1.4 g/10-min, melting point: 162° C.)

Polypropylene Resin (a′1)

Homopropylene homopolymer (E-200GP, available from Prime Polymer Co., Ltd., MFR: 2.0 g/10-min, melting point: 164° C.)

Polypropylene Resin (a′2)

Propylene-α-olefin random copolymer (B-241, available from Prime Polymer Co., Ltd., MFR: 0.5 g/10-min, melting point: 143° C.)

### <(B) Antioxidant>

### Phenol-Type Antioxidant (b1)

Pentaerythritol tetrakis[3-(3,5-di-tert-butyl-4-hydroxyphenyl) propionate] (Irganox 1010, available from BASF SE, melting point: 110 to 125° C.)

### Phenol-Type Antioxidant (b2)

2,2′-Thiodiethyl bis[3-(3,5-di-tert-butyl-4-hydroxyphenyl) propionate] (Irganox 1035, available from BASF SE, melting point: 63 to 78° C.)

Phenol-Type Antioxidant (b′)

n-Octadecyl-3-(3,5-di-tert-butyl-4-hydroxyphenyl) propionate (Irganox 1076, available from BASF SE, melting point: 50 to 55° C.)

### <Filler>

### Inorganic Filler

Talc (FH108, available from FUJI TALC INDUSTRIAL CO., LTD.)

### Examples 1 to 3 and Comparative Examples 1 to 5

Components except for the inorganic filler with mass proportions and combination described in Table 1 below were kneaded at 200° C. for 5 minutes with a biaxial kneading extruder (TEM-18SS, available from SHIBAURA MACHINE CO., LTD.), then the inorganic filler was added, and the mixture was further kneaded at 200° C. for 5 minutes with the above biaxial kneading extruder to obtain a kneaded product (resin composition).

Then, the kneaded product was formed into pellets, and these pellets were melt-extruding formed into a tube shape at 250° C. with a melt-extruding forming machine (GT-40, available from Research Laboratory of Plastics Technology Co., Ltd.) equipped with a cylindrical die to obtain a resin tube with 18 mm in inner diameter and 20 mm in outer diameter.

### Example 4

Components with mass proportions and combination described in Table 1 below were kneaded at 200° C. for 5 minutes with a biaxial kneading extruder (TEM-18SS, available from SHIBAURA MACHINE CO., LTD.) to obtain a kneaded product (resin composition).

Then, the kneaded product was formed into pellets, and these pellets were melt-extruding formed into a tube shape at 250° C. with a melt-extruding forming machine (GT-40, available from Research Laboratory of Plastics Technology Co., Ltd.) equipped with a cylindrical die to obtain a resin tube with 18 mm in inner diameter and 20 mm in outer diameter.

The resin tubes of Examples and Comparative Examples obtained as above were subjected to evaluations for properties in accordance with the following criteria. Table 1 below also shows the results.

### <<Heat Resistance Test>>

The resin tube was cut into half, and punched into a strip shape with 10 mm in width and 15 cm in length. The strip sample obtained as above was subjected to a thermal aging treatment (a thermal treatment of 130° C.×500 hours or a thermal treatment of 130° C.×750 hours), and then an elongation [Eb] at breakage of the sample was measured in accordance with JIS K6251 with a tensile tester (AGS-X, available from SHIMADZU CORPORATION).

As a result, a sample in which the elongation of the sample in the thermal treatment of 130° C.×500 hours was not less than 50% of the length of the sample was evaluated as “Very good”, and a sample in which the elongation was less than 50% of the length of the sample was evaluated as “Poor.”

A sample in which the elongation of the sample in the thermal treatment of 130° C.×750 hours was not less than 50% of the length of the sample was evaluated as “Excellent.”

### <<Extraction Resistance Test>>

By using the obtained resin composition, an injection sheet (a sample) with 2 mm in thickness was produced under a condition at a temperature of 200° C.

Subsequently, a resin piece in 2.8-cm square was punched from this sheet. This resin piece (10 g) was sealed in a 100-ml polypropylene container equipped with a lid together with 100 ml of a coolant (ethylene glycol 50% aqueous solution), and subjected to a thermal treatment at 100° C. for 72 hours to extract components in the rubber piece. Thereafter, the resultant was filtered under a reduced pressure by using filter paper having a filter diameter of 8 μm, air-dried (70° C.×24 hours), and a mass X (g) of the air-dried rubber piece was measured.

Based on the mass (10 g) of the rubber piece before the extraction and the above mass X (g), an extraction rate (%) was determined.

$$Extraction rate ( \% ) = [ 10 ( g ) - \times ( g ) ] / 10 ( g ) \times 100$$

As a result, a sample with an extraction rate (%) of not less than 0.05% and less than 1.0% was evaluated as “Very good,” and a sample with not less than 1.0% was evaluated as “Poor.”

A sample with an extraction rate (%) of less than 0.05% was evaluated as “Excellent.”

TABLE 1

| | | MFR | Melting | | | | | | | | | |
|---|---|---|---|---|---|---|---|---|---|---|---|---|
| | | (g/10- | point | Example | | | | Comparative Example | | | | |
| | | min) | (° C.) | 1 | 2 | 3 | 4 | 1 | 2 | 3 | 4 | 5 |
| (A) | Polypropylene | 1.4 | 162 | 100 | 100 | 100 | 100 | — | — | 100 | 100 | 100 |
| | resin (a) | | | | | | | | | | | |
| (A′) | Polypropylene | 2.0 | 164 | — | — | — | — | 100 | — | — | — | — |
| | resin (a′1) | | | | | | | | | | | |
| | Polypropylene | 0.5 | 143 | — | — | — | — | — | 100 | — | — | — |
| | resin (a′2) | | | | | | | | | | | |
| (B) | Phenol-type | — | 110~125 | — | 0.5 | — | — | — | — | — | — | — |
| | antioxidant (b1) | | | | | | | | | | | |
| | Phenol-type | — | 63~78 | 0.5 | — | 1 | 0.1 | 0.5 | 0.5 | — | 0.05 | 1.5 |
| | antioxidant (b2) | | | | | | | | | | | |
| (B′) | Phenol-type | — | 50~55 | — | — | — | — | — | — | 0.5 | — | — |
| | antioxidant (b′) | | | | | | | | | | | |
| | Inorganic filler | — | — | 30 | 30 | 30 | — | 30 | 30 | 30 | 30 | 30 |

| | | | | | | | | | | |
|---|---|---|---|---|---|---|---|---|---|---|
| Evaluation | Heat resistance | Good | Excellent | Excellent | Good | Good | Poor | Good | Poor | Excellent |
| | (130° C. × 500 h,750 h) | | | | | | | | | |
| | Extraction resistance | Good | Excellent | Good | Excellent | Poor | Good | Poor | Excellent | Poor |
| | (100° C. × 72 h) | | | | | | | | | |

From the results in Table 1, all the resin tubes of Examples 1 to 4 exhibited excellent heat resistance and extraction resistance.

In contrast, Comparative Example 1, which used the polypropylene resin having an MFR of 2.0 g/10-min, resulted in poor extraction resistance, and failed to achieve at least one of the heat resistance and the extraction resistance.

Comparative Example 2, which used the polypropylene resin having a melting point of 143° C., resulted in poor heat resistance, and failed to achieve at least one of the heat resistance and the extraction resistance.

Comparative Example 3, which used the antioxidant having a melting point of 50 to 55° C., resulted in poor extraction resistance, and failed to achieve at least one of the heat resistance and the extraction resistance.

Comparative Examples 4 and 5 in which the blending rate of the antioxidant relative to the polypropylene resin was “0.05 parts by mass” or “1.5 parts by mass” failed to achieve at least one of the heat resistance and the extraction resistance.

From the above test results, it has been confirmed that the vehicle coolant transport tube having excellent heat resistance and extraction resistance can be obtained by using the resin composition containing: the polypropylene resin (A) having a melt-flow rate, measured at 230° C. with a load of 2.16 kg, of “not less than 0.2 g/10-min and less than 2.0 g/10-min” and a melting point of “not lower than 145° C.”; and the antioxidant (B) having a melting point of “not lower than 60° C.,” wherein the content of the component (B) relative to 100 parts by mass of the component (A) is “0.1 to 1 part by mass.”

The specific embodiments of the present disclosure have been described in the above Examples, but the Examples are merely examples, and not limitedly interpreted. It is anticipated that various modifications obvious to a person skilled in the art are within the scope of the present disclosure.

### INDUSTRIAL APPLICABILITY

The vehicle coolant transport tube obtained by the present disclosure is used for, for example, a pipe for a coolant in automobiles, and specifically used for a radiator hose, a heater hose, an air conditioner hose, etc., and a cooling tube of a battery pack for electric automobiles and fuel-cell automobiles. The vehicle coolant transport tube is usable as a cooling tube for not only automobiles but also other transportation machines (industrial transportation vehicles such as airplanes, forklifts, excavators, and crane vehicles, and railway vehicles) and vending machines.

1. A resin composition for a vehicle coolant transport tube, the resin composition comprising:
a component (A): a polypropylene resin having a melt-flow rate of not less than 0.2 g/10-min and less than 2.0 g/10-min and having a melting point of not lower than 145° C., wherein the melt-flow rate is measured at 230° C. with a load of 2.16 kg; and
a component (B): an antioxidant having a melting point of not lower than 60° C.,
wherein a content of the component (B) relative to 100 parts by mass of the component (A) is 0.1 to 1 part by mass.

2. The resin composition for a vehicle coolant transport tube according to claim 1, wherein the component (A) is a propylene-α-olefin block copolymer.

3. The resin composition for a vehicle coolant transport tube according to claim 1, wherein the melt-flow rate of the component (A) is not less than 0.2 g/10-min and not more than 1.5 g/10-min.

4. The resin composition for a vehicle coolant transport tube according to claim 1, wherein the melting point of the component (B) is not lower than 90° C.

5. The resin composition for a vehicle coolant transport tube according to claim 1, wherein the component (B) is a phenol-type antioxidant.

6. The resin composition for a vehicle coolant transport tube according to claim 1, wherein the component (B) is a hindered-phenol-type antioxidant.

7. A vehicle coolant transport tube, comprising the resin composition for a vehicle coolant transport tube according to claim 1.
